(19) United States
(12) Patent Application Publication
(10) Pub. No.: US 2012/0204161 A1
(43) Pub. Date: Aug. 9, 2012

(54) Automated Code Map Generation for an Application Programming Interface of a Programming Language

(75) Inventors: Guy Ben-Artzi, Palo Alto, CA (US); Yotam Shacham, Palo Alto, CA (US); Yehuda Levi, Rishon Lezion (IL)

(73) Assignee: Particle Code, Inc., Palo Alto, CA (US)

(21) Appl. No.: 13/023,706

(22) Filed: Feb. 9, 2011

(51) Int. Cl. G06F 9/45

(52) U.S. Cl. 717/137

(57) ABSTRACT

Generating a code map for an application program interface (API) of a programming language may include analyzing at least one feature of the API to identify a plurality of atomic code snippets associated with the at least one feature and assigning an identifier to at least one of the plurality of atomic code snippets. The identifier may also be associated with a pre-stored atomic code snippet, in a second language. A code map may be generated to associate the at least one of the plurality of atomic code snippets to the prestored atomic code snippet.

### FIELD OF THE INVENTION

Embodiments of the invention may relate to computer aided translation of programming code and more specifically to generation of code maps for an application programming interface of a programming language.

### BACKGROUND OF THE INVENTION

Various users across the globe communicate or perform various activities on computer and device networks. Moreover, the users interact with each other through the networks, such as the Internet. Typically, the users use devices like personal computers to interact over the Internet. The users can interact from various Internet websites or social networking sites, for example, Facebook, Myspace, Hi5, and Orkut etc. Recently, the development in mobile devices such as cell phones, smart phones and PDAs, computers laptops and the like has enabled them to be used for performing various activities on networks such as the Internet. Moreover, the mobile devices can be used for real-time interaction with other users on the network. The interaction or communication can be in the form of chatting, playing interactive online games, browsing, shopping, music, video, banking, business and the like.

The rapid pace of innovation in technology has generated various types of devices and platforms. Moreover, the number of devices is increasing rapidly. For example, there are various operating systems available for the devices such as Windows, Linux, Macintosh, Android, and Symbian, etc. Moreover, a large number of J2ME platforms are available for the mobile devices such as cell phones. Furthermore, the mobile devices have a wide range of capabilities in terms of screen size, screen type, screen resolution, processor, and memory etc. The applications for these devices have to be developed based on their platforms. Therefore, each application has to be ported to other platforms. For example, in the case of computer games, the programming languages typically used are JAVA, C#, C++, Action Script, and the like. Therefore, an application developed in Action Script programming language may have to be ported to another programming language if Action Script is not supported by a device platform. Further, new applications are being continuously developed for different device platforms.

Generally, one may wish to translate program code written in a source computer language for a source Operating System (OS) or device platform into multiple target computer languages for various target operating systems or device platforms. However, the translation may be difficult to perform due to various challenges. One of the major challenges is to translate the program code from the source programming language into one or more target programming languages. The process requires a lot of inputs from the programmer and often ends up taking in duplicate inputs from the programmer. One solution to the problem is to build a database that maps the features of various programming languages. But, the process of building and updating this database is even more time consuming and complicated.

In light of the above discussion, techniques are therefore desirable to generate an automated code map for an application programming interface of a programming language.

### SUMMARY

Embodiments of the invention may provide a method for generating, at a processing device, a code map for an application program interface (API) of a programming language. The method may comprise: analyzing at least one feature of the API to identify a plurality of atomic, code snippets associated with the at least one feature; assigning an identifier to at least one of the plurality of atomic code snippets, wherein the identifier is also associated with a pre-stored atomic code snippet, in an intermediate language; and generating a code map to associate the at least one of the plurality of atomic code snippets to the pre-stored atomic code snippet.

Embodiments of the present invention may further provide a system for generating, e.g., at a processing device, a code map for an application program interface (API) of a programming language. The system may comprise: means for analyzing at least one feature, of the API, to identify a plurality of atomic code snippets associated with the at least one feature; means for assigning an identifier to at least one of the plurality of atomic code snippets, wherein the identifier is also associated with a pre-stored atomic code snippet, in an intermediate language; and means for generating a code map to associate the at least one of the plurality of atomic code snippets to the pre-stored atomic code snippet.

Embodiments of the present invention may further provide an apparatus for generating a code map for an application program interface (API) of a programming language. The apparatus may comprise: a processor to: analyze at least one feature, of the API, to identify a plurality of atomic code snippets associated with the at least one feature; assign an identifier to at least one of the plurality of atomic code snippets, wherein the identifier is also associated with a pre-stored atomic code snippet, in an intermediate language; and generate a code map to associate the at least one of the plurality of atomic code snippets to the pre-stored atomic code snippet.

Embodiments of the present invention may further provide a computer-readable medium having stored thereon instructions that, if executed by a processor, cause the processor to execute a method for generating a code map for an application program interface (API) of a programming language, where the method may comprise: analyzing at least one feature, of the API, to identify a plurality of atomic code snippets associated with the at least one feature; and assigning an identifier to at least one of the plurality of atomic code snippets, wherein the identifier is also associated with a pre-stored atomic code snippet, in an intermediate language; and generating a code map to associate the at least one of the plurality of atomic code snippets to the pre-stored atomic code snippet.

### BRIEF DESCRIPTION OF THE DRAWINGS

Having thus described the invention in general terms, reference will now be made to the accompanying drawings, which are not necessarily drawn to scale, and wherein:

FIG. 1 illustrates an environment where various embodiments of the invention may function;

FIG. 2 illustrates a block diagram showing exemplary components of an processing device for implementing the invention, in accordance with an embodiment of the invention;

FIG. 3 illustrates various components of a map generator for managing translation, in an embodiment of the invention; and

FIGS. 4A, 4B, and 4C are flowcharts illustrating a method for generating an automated code map for an application programming interface of a language, according to an embodiment of the invention.

### DESCRIPTION OF VARIOUS EMBODIMENTS OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

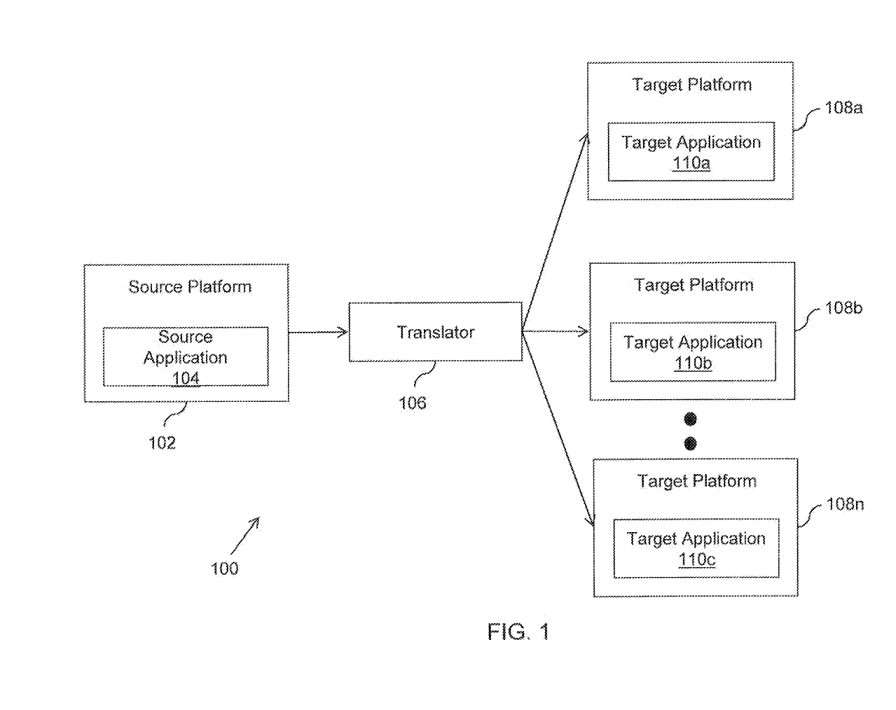

FIG. 1 illustrates an exemplary environment 100 where the embodiments of the invention may function. Generally, computer application's may be designed for a particular platform of a device based on the characteristic's of the platform. For example, characteristics may include, but are not limited to, the Operating System (OS), processor, memory, display capabilities, audio capability, video capability and so forth. Further, various platforms may only support applications written in specific programming languages. Therefore, the applications may be required to be translated for using them on target platforms. As shown with reference to FIG. 1, a map generator 106 may translate an API of a source language executing on a source platform 102 to target languages 110a-n of respective target platforms 108a-n. Typically, when translating a source code into a code in one or more target languages, map generator 106 may first construct code maps to associate an API of each programming language with a pre-stored code snippet of one or more programming languages, and vice versa. The term “code map” used herein refers to a database that maps each atomic code snippet, in the API of a first language, to a corresponding pre-stored atomic code snippet of a second language, and vice versa.

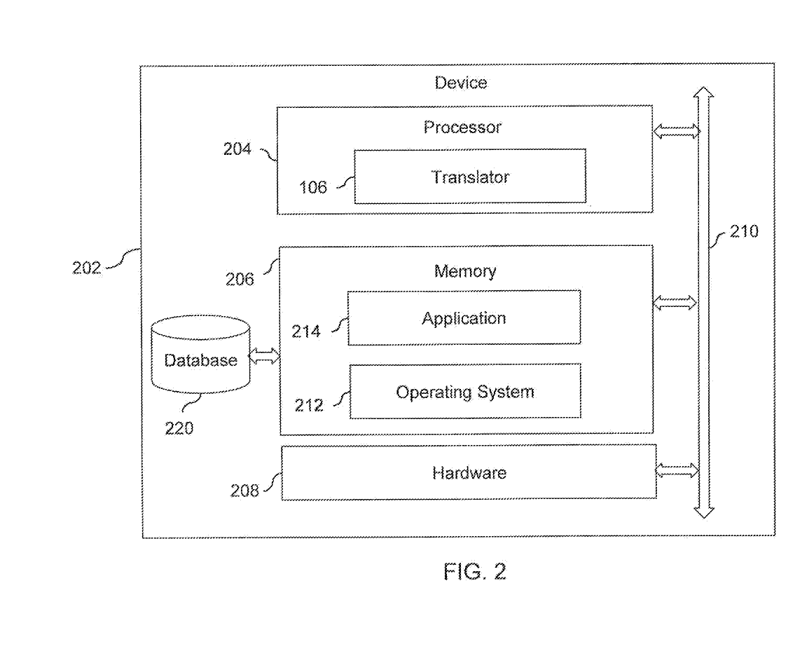

However, constructing a code map for each programming language is a complicated and time consuming process, and the process of constructing the code map can be automated using the teachings of the disclosure herein, as described with reference to FIGS. 2, 3, and 4A, 4B, and 4C.

With reference to FIG. 2, exemplary components of a processing device 202 are illustrated where map generator 106 may be implemented, according to an embodiment of the invention. As shown, map generator 106 may be a component of processing device 202; however, a person skilled in the art will appreciate that map generator 106 may function as independent hardware, software or firmware. Device 202 may be a computer, a laptop, a mobile phone, a smartphone, and so forth. Further, processing device 202 may include a processor 204, a memory 206, and hardware 208. Hardware 208 may include various Input/Output (IO) modules, network interfaces, Graphical User Interface (GUI) or other hardware that enable processing device 202 to connect and/or communicate with other devices, hardware or users. Memory 206 may include application 214, and an OS 212, such as, but not limited to, Windows, Linux, Macintosh, Android, Symbian, and so forth, that may support functioning of various applications on device 202. Examples of memory 206 may include a Read Only Memory (ROM), a Random Access Memory (RAM), a hard disk, a solid-state disk or any other media that can store instructions or data. Processor 204 can execute the information or data stored in memory 206. Processor 204, memory 206 and hardware 208 may communicate with each other through a system bus 210. Although not shown, a person skilled in the art will appreciate that device 202 may include various other components to enable its functioning.

Map generator 106 may identify each atomic feature/code snippet of an application program interface (API) of a first programming language. Thereafter, map generator 106 may associate each atomic code snippet with a pre-stored atomic code snippet, where the pre-stored atomic code snippet is in a second programming language. The term “atomic code snippet” used herein refers to a code snippet that forms the basic code structure required for any programming code to function. Therefore, the atomic code snippet provides functionality to the programming codes. An example of atomic code snippet that provides a basic structure for incrementing or decrementing value of a counter in JAVA programming language:

import java.util.concurrent.atomic.AtomicInteger;
class AtomicCounter {

private AtomicInteger c = new AtomicInteger(0);
public void increment( ) {

c.incrementAndGet( );

}
public void decrement( ) {

c.decrementAndGet( );

}
public int value( ) {

return c.get( );

}

}

The above code may be used by complex programming codes if a functionality of increasing or decreasing a value is required.

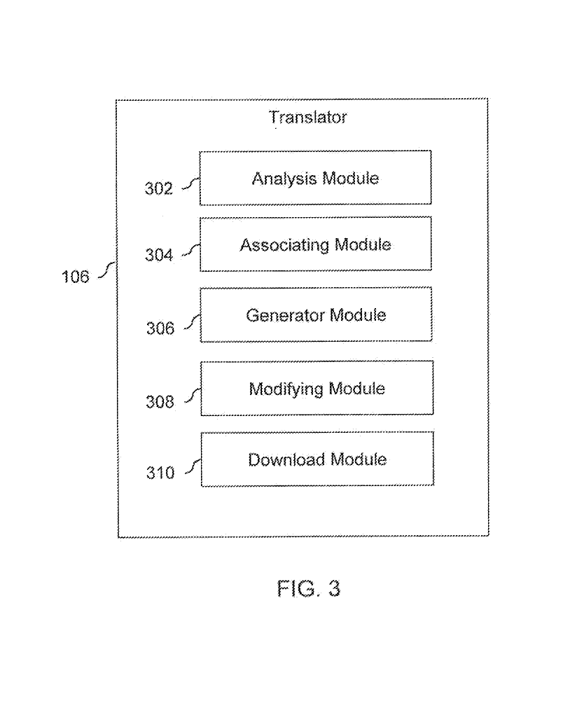

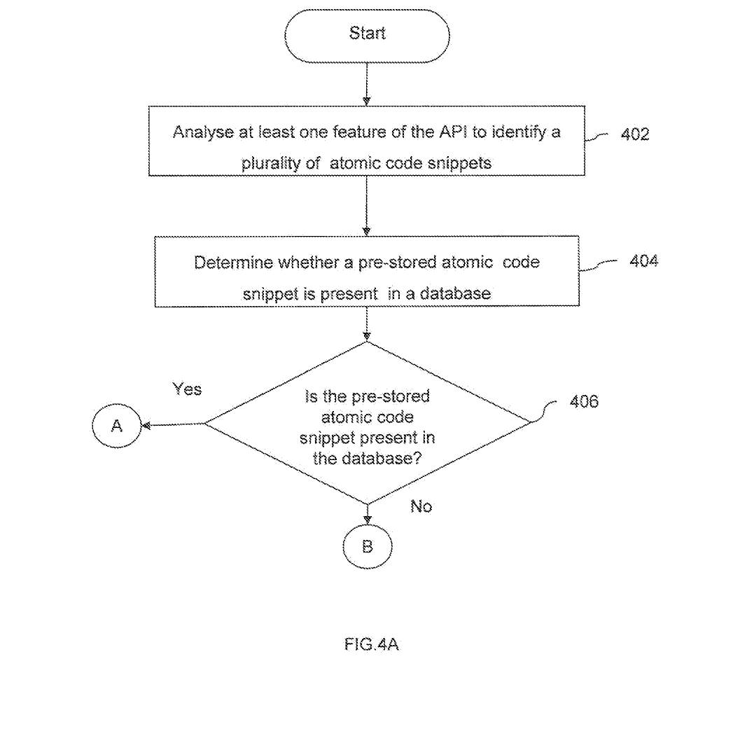

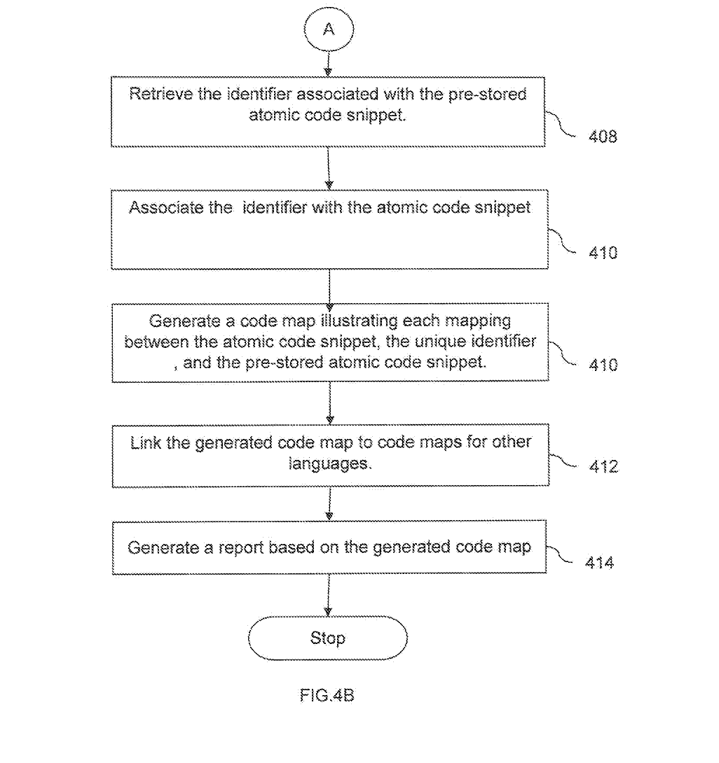

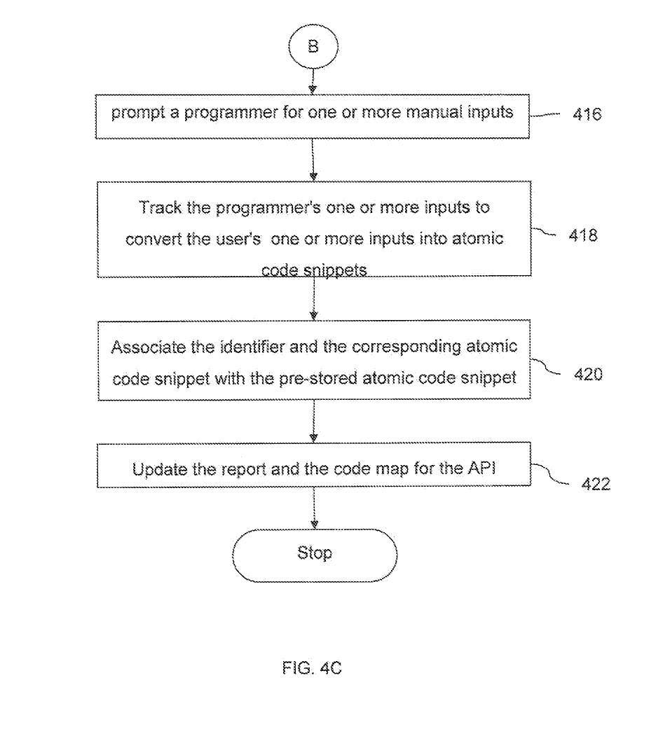

Further, map generator 106 may use information stored in a database 220 for this association. Database 220 may include information regarding the code snippets in multiple languages, data for identifying and processing codes, and so forth. For instance, database 220 may include code maps for a plurality of programming languages, where each code map may illustrate one or more mappings between the features of the APIs of multiple programming languages. Database 220 and the functioning of map generator 106 are explained in more detail in conjunction with FIGS. 3 and 4.

FIG. 3 illustrates components of the map generator 106, in accordance with an embodiment of the invention. As discussed above, map generator 106 may manage translation of features of the API of the first programming language to one or more target programming languages. It would be apparent to a person with ordinary skill in the art that one or more modules of map generator 106 can be implemented with a processor such as the processor 204, illustrated in FIG. 2. Map generator 196 may include an analysis module 302 that may analyze features of the API to identify one or more atomic code snippets associated with the features. Moreover, analysis module 302 may also determine if a corresponding pre-stored code snippet, for the atomic code snippet, is present in a database 220.

Map generator 106 may also comprise an associating module 304 that may associate a unique identifier with the equivalent atomic code snippet. In other words, associating module 304 may associate the atomic code snippet with the corresponding pre-stored code snippet, via an identifier. Moreover, map generator 106 may also comprise a generator module 306 that may generate a code map that may illustrate a mapping between the atomic code snippets, the identifier, and the pre-stored atomic code snippets. Once generator module 306 generates the code map, the association module 304 may then associate the code map with the pre-stored code maps of different languages. This may help to ensure seamless translation between the APIs of different programming language. Generator module 306 may also generate a report that may describe various parameters associated with the generated and associated code maps. Moreover, map generator 106 may also comprise a modifying module 308 that may modify the code maps and reports. Lastly, map generator 106 may comprise a download module 310 that may be used to download the corresponding code snippets from other databases, in the network. Moreover, download module 308 may also download the executable instructions for performing the above mentioned processes. In an embodiment of the invention, download module 308 may download the instructions from a communication network, such as the Internet, or from one or more computer media. Even though the modules have been shown comprised within map generator 106, people with ordinary skill in the art would appreciate that these modules can exist as independent hardware, software, or firmware or a combination thereof and may further be performed at a single hardware device or a combination of hardware devices at multiple devices. It is further noted that executable instructions to perform the above processes (and those described below) may be made available for downloading via a communication network, such as the Internet.

FIGS. 4A, 4B, 4C, and 4D depict flow diagrams for an exemplary method for generating, at a processing device, a code map for an application program interface (API) of a programming language, according to an embodiment of the invention. The process depicted can also be implemented in a processing device capable of performing interactive testing of a program code. Further, it should also be realized that the process may include functionality that may be performed in hardware, firmware, software, or a combination thereof and may further be performed at a single hardware device or a combination of hardware devices at multiple devices. Also, one or more steps of the process can be facilitated by supporting external hardware units. Further, the various steps in the process may be executed by processor 204.

As discussed above, map generator 106 may manage translation of features of the API of the first programming language to one or more target programming languages. It would be apparent to a person with ordinary skill in the art that one or more modules of map generator 106 can be implemented with a processor such as the processor 204, illustrated, in FIG. 2. At step 402, processor 204 may analyze (402) features of the API of a first programming language, to identify one or more atomic code snippets associated with the features.

Subsequently at step 404, processor 204 may query a database 220 to determine if a pre-stored code snippet, in a second language, is present. Database 220 may comprise a unique identifier associated with each pre-stored atomic code snippet, which can be used as an index for database 220. Moreover, the unique identifier may also be used for associating the atomic code snippets with the pre-stored atomic code snippets. Processor 204 may also check for the presence of the pre-stored atomic code snippets in other programming languages. For instance, if processor 204 is associating an API for Action Script with the pre-stored atomic code snippets of Java, processor 204 may also check the code map for C++ to determine the equivalent pre-stored atomic code snippet for “classes.” This may help to prevent processor 204 from needing to perform duplicate code processing. In one embodiment, the pre-stored atomic code snippet may provide super set codes for the corresponding atomic code snippet. The term “super set code,” used herein, can be described as a code snippet that is universal or supported by both the API of the first programming language and the API of the target programming language. As a result, the time required for actual translation is drastically reduced.

In an embodiment of the invention, the pre-stored code snippets may be templates that can be used to replace the atomic code snippets. An exemplary template can be one such as:

| | |
|---|---|
| 1. | <Object type> T |

| | |
|---|---|
| 2. | fn( const T* s, const T* t, int limit); |

If processor 204 determines an absence of the pre-stored atomic code snippet, the process may switch to step 416. If processor 204 determines a presence of the pre-stored atomic code snippet, the process may switch to step 408. At step 408, processor 204 may retrieve the identifier associated with the pre-stored atomic code snippet Once the unique identifier is retrieved for each applicable pre-stored atomic code snippet, processor 204 may associate the unique identifier with the equivalent atomic code snippet, at step 410. Even though it is described that the association of identifiers to their equivalent atomic code snippets may be done after all the unique identifiers are generated, a person with skill in the art would appreciate that the step of association can also be done in parallel with the retrieving of the unique identifier.

Subsequently, at step 410, processor 204 may generate a code map that may illustrate a mapping between the atomic code snippets, the identifier, and the pre-stored atomic code snippets. The code map as described herein is a mapping, which may be stored in a database, that associates the atomic code snippets of different languages. In one embodiment, the code map may be similar to the database illustrated in Table 1.

TABLE 1

| | Unique | Pre-Stored Atomic | Parameter |
|---|---|---|---|
| Feature | identifier | Code snippet | Markers |
| For-loop | | | |
| Atomic_Code_1.1 | #1245 | Pre_Atomic_Code_1.15 | Data Type, Initial value |
| Atomic_Code_1.2 | #1246 | Pre_Atomic_Code_1.16 | Number of iterations |
| Atomic_Code_1.3 | #1247 | Pre_Atomic_Code_1.17 | End of loop condition |
| If clause | | | |
| Atomic_Code_2.1 | #2245 | Pre_Atomic_Code_2.15 | Conditional clause |
| Atomic_Code_2.2 | #2246 | Pre_Atomic_Code_2.16 | IF_True_operation |
| Atomic_Code_2.3 | #2247 | Pre_Atomic_Code_2.17 | If_False_operation |

Once processor 204 generates the code map, the processor 204 may associate the code map with pre-stored code maps of different languages. This may help to ensure seamless translation between the APIs of different programming languages. Thereafter, the process may switch to step 412. At step 412, processor 204 may generate a report describing various parameters that may be associated with the generated and/or associated code maps. The report may include parameters such as: a total number of atomic code snippets, number of features of the API associated with each atomic code snippet; unique identifier associated with each atomic code snippet, and an association of the pre-stored atomic code snippets to the atomic code snippets. A person with skill in the art would appreciate that these are just a few examples and that other parameters can also be included in the reports. Moreover, a user of map generator 106 may be able to customize the report and/or code map. Once the user enters or suggests one or more customization parameters, processor 204 may modify the code maps and reports in accordance with the suggested or entered parameters.

An advantage of this method is that it helps to automate the translation process and may also bring down the complexity, as compared to legacy translation processes. Moreover, embodiments of the invention may incorporate a self-learning method that may improve performance with time.

If processor 204 determines an absence of the pre-stored syntactical identifier corresponding to the unique identifier, the process may switch to step 416. At step 416, processor 204 may prompt the user of map generator 106 to manually provide a transit atomic code snippet. Thereafter, processor 204 may track (418), the user's inputs and may re-source the inputs into one or more pre-stored atomic code snippets. In an embodiment of the invention, re-sourcing may correspond to editing the pre-stored code snippets based on the user's inputs to generate re-sourced atomic code snippets. Once the corresponding pre-stored atomic code snippets are re-sourced, processor 204 may index the re-sourced atomic code snippet with a unique identifier. Thereafter, at step 420, processor 204 may associate the unique identifier with the atomic code snippet, and thus may associate the atomic code snippet with the re-sourced atomic code snippet. Subsequently, at step 422, the processor 204 may update the code map and/or the report to reflect the changes and the newly added transit atomic code snippet. In one embodiment, if the user of the map generator 106 is unable to provide the inputs, processor 204 may download the corresponding code snippets from other databases in the network. Moreover, processor 204 may also download the executable instructions for performing the above mentioned processes. In an embodiment of the invention, processor 204 may download the instructions from a communication network, such as the Internet or from one or more computer media.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general-purpose computers, special purpose computers, or other programmable data processing apparatus to produce machines, such that the instructions which execute on the computers or other programmable data processing apparatus create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. Furthermore, such computer program instructions may be made available for download and/or downloaded over a communication network.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for generating, at a processing device, a code map for an application program interface (API) of a first programming language, the method comprising:
analyzing at least one feature of the API to identify one or more atomic code snippets associated with the at least one feature;
assigning an identifier to at least one of the one or more atomic code snippets, wherein the identifier is also associated with at least one pre-stored atomic code snippet, in a second programming language; and
generating a code map to associate the at least one of the one or more atomic code snippets to the at least one pre-stored atomic code snippet.

2. The method of claim 1, further comprising:
querying a database to determine a presence of the at least one pre-stored atomic code snippet.

3. The method of claim 1, wherein the at least one pre-stored atomic code snippet comprises a super set code, wherein the super set code is a code that is supported by both the first and second languages.

3. (canceled)

4. The method of claim 2, further comprising:
if the processing device determines an absence of the at least one pre-stored atomic code snippet:
prompting a user of the processing device for one or more inputs;
tracking the one or more inputs; and
re-sourcing the one or more inputs as one or more atomic code snippets in the database.

5. The method of claim 4, further comprising:
updating the code map by associating at least one of the re-sourced one or more atomic code snippet with at least one of the one or more atomic code snippets.

6. The method of claim 1, wherein assigning an identifier further comprising: assigning a marker to respective ones of the one or more atomic code snippets, wherein the marker identifies one or more parameters associated with the respective ones of the one or more atomic code snippets.

7. The method of claim 1, further comprising downloading executable instructions that, if executed by the processing device, cause the processing device to perform operations to implement said analyzing, said assigning, and said generating.

8. The method of claim 1, wherein the code map describes an association between respective ones of the one or more atomic code snippets, in the first language, and the at least one pre-stored atomic code snippet, in the second language.

9. The method of claim 1, further comprising:
associating the generated code map, for the first language, with one or more code maps, of one or more other programming languages, wherein said associating comprises linking atomic code snippets of the first programming language with corresponding atomic code snippets of one or more programming languages.

10. The method of claim 1, further comprising providing for downloading executable instructions that, if executed by a processing device, result in the performance of operations to implement said analyzing, said assigning, and said generating.

11. An apparatus for generating a code map for an application program interface (API) of a first programming language, the apparatus comprising:
a processor configured to:
analyze at least one feature, of the API, to identify one or more atomic code snippets associated with the at least one feature;
assign an identifier to at least one of the one or more atomic code snippets, wherein the identifier is also associated with at least one pre-stored atomic code snippet, in a second language; and
generate a code map to associate the at least one of the one or more atomic code snippets to the at least one pre-stored atomic code snippet.

12. The apparatus of claim 11, further comprising:
a memory communicatively coupled to the processor, the memory configured to store a database comprising pre-stored atomic code snippets.

13. The apparatus of claim 11, wherein the processor is further configured to query a database to determine a presence of the at least one pre-stored atomic code snippet.

14. The method of claim 12, wherein the memory is also configured to store: pre-stored atomic code snippets, code maps for one or more programming languages, or both.

15. The apparatus of claim 12, wherein, if the processor determines an absence of the at least one pre-stored atomic code snippet, the processor is further configured to:
prompt a user, of the processing device, for one or more inputs;
track the one or more inputs; and
re-source the one or more inputs as one or more atomic code snippets in the database.

16. The apparatus of claim 15, wherein the processor is further configured to update the code map by associating at least one of the re-sourced one or more atomic code snippets with at least one of the one or more atomic code snippets.

17. The apparatus of claim 11, wherein the processor is further configured to associate the generated code map, for the first language, with one or more code maps, of one or more other programming languages, wherein the associating includes linking atomic code snippets of the first programming language with atomic code snippets of one or more of the other programming languages.

18. The apparatus of claim 11, wherein the processor is further configured to assign a marker to respective ones of the one or more atomic code snippets, wherein the marker identifies one or more parameters associated with the respective ones of the one or more atomic code snippets.

19. A system for generating, at a processing device, a code map for an application program interface (API) of a first programming language, the system comprising:
means for analyzing at least one feature, of the API, to identify one or more atomic code snippets associated with the at least one feature;
means for assigning an identifier to at least one of the one or more atomic code snippets, wherein the identifier is also associated with at least one pre-stored atomic code snippet, in a second language; and
means for generating a code map to associate the at least one of the one or more atomic code snippets to the at least one pre-stored atomic code snippet.

20. The system of claim 19, further comprising:
means for querying a database to determine a presence of the at least one pre-stored atomic code snippet.

21. The system of claim 19, wherein the at least one pre-stored atomic code snippet comprises a super set code, wherein the super set code is a code that is supported by both the first and second languages.

22. The system of claim 20, wherein the database comprises: pre-stored atomic code snippets, code maps for one or more programming languages, or both.

23. The system of claim 20, further comprising:
means for prompting a user for one or more inputs if the means for querying determines an absence of the at least one pre-stored atomic code snippet;
means for tracking the one or more inputs; and
means for re-sourcing the one or more inputs as one or more atomic code snippets in the database.

24. The system of claim 22, further comprising:
means for updating the code map by associating at least one of the re-sourced one or more atomic code snippet with the at least one atomic code snippet.

25. The system of claim 19, wherein the means for assigning an identifier further comprises:
means for assigning a marker to respective ones of the one or more atomic code snippets, wherein the marker identifies one or more parameters associated with the respective ones of the one or more atomic code snippets.

26. The system of claim 19, wherein the code map describes associations between atomic code snippets, in the first language, and pre-stored atomic code snippet, in the second language.

27. The system of claim 19, further comprising:
means for associating the generated code map, for the first language, with one or more code maps, of one or more other programming languages, wherein the means for associating is configured to link atomic code snippets of the first programming language with atomic code snippets of one or more other programming languages.

28. A computer-readable medium having stored thereon instructions that, if executed by a processor, cause the processor to execute operations relating to generating a code map for an application program interface (API) of a first programming language, the operations comprising:
analyzing at least one feature of the API to identify one or more atomic code snippets associated with the at least one feature;
assigning an identifier to at least one of the one or more atomic code snippets, wherein the identifier is also associated with at least one pre-stored atomic code snippet, in a second language; and
generating a code map to associate the at least one of the one or more atomic code snippets to the at least one pre-stored atomic code snippet.

29. The computer readable medium of claim 28, further comprising instructions for:
querying a database to determine a presence of the at least one pre-stored atomic code snippet.

30. The computer readable medium of claim 29, further comprising instructions for:
prompting a user for one or more inputs if said querying determines an absence of the at least one pre-stored atomic code snippet in the database;
tracking the one or more inputs; and
re-sourcing the one or more inputs as one or more atomic code snippets in the database.

31. The computer readable medium of claim 30, further comprising instructions for:
updating the code map by associating at least one of the re-sourced one or more atomic code snippets with the at least one atomic code snippet.

32. The computer readable medium of claim 30, further comprising instructions for:
assigning a marker to respective ones of the one or more atomic code snippets, wherein the marker identifies one or more parameters associated with the respective ones of the one or more atomic code snippets.

33. The computer readable medium of claim 28, further comprising instructions for:
associating the generated code map, for the first language, with one or more code maps, of one or more other programming languages, wherein the associating comprises linking atomic code snippets of the first programming language with atomic code snippets, of one or more other programming languages.

34. The method of claim 2, wherein the database comprises: one or more pre-stored atomic code snippet, one or more code maps for one or more programming languages, or both.
